(19) United States
(12) Patent Application Publication
(10) Pub. No.: US 2004/0060385 A1
(43) Pub. Date: Apr. 1, 2004

(54) One-piece axle tube housing assembly

(76) Inventor: Bryan P. Prucher, Clarkston, MI (US)

Correspondence Address: HARNESS, DICKEY & PIERCE, P.L.C., P.O. BOX 828, BLOOMFIELD HILLS, MI, 48303, US

(21) Appl. No.: 10/645,943

(22) Filed: Aug. 22, 2003

Related U.S. Application Data
(60) Provisional application No. 60/411,473, filed on Sep. 16, 2002.

(51) Int. Cl. F16H 57/02

(52) U.S. Cl. 74/607

(57) ABSTRACT

A method of manufacturing an axle tube housing for a differential assembly includes heating a localized area of a one-piece tubular blank. A mandrel is inserted within the tubular blank and the localized area is then deformed to provide an increased wall thickness. A compression force is applied to the localized area of the one-piece tubular blank using a forging die to form a spindle section, wherein the spindle section closely conforms to at least one of the forging die and the mandrel. The remaining portion of the one-piece tubular blank is then cold reduced to form a carrier section.

### CROSS-REFERENCE TO RELATED APPLICATIONS

This application claims the benefit of U.S. Provisional Application No. 60/411,473, filed on Sep. 16, 2002. The disclosure of the above application is incorporated herein by reference.

### FIELD OF THE INVENTION

The present invention generally relates to axle tube housing assemblies and, more particularly, relates to an axle tube housing being integrally formed from a one-piece member.

### BACKGROUND OF THE INVENTION

As is well-known in the art, motor vehicles often employ driveline systems wherein rotary power is distributed by a differential to a pair of axle shafts. Typically, these axle shafts are disposed in axle tube housings, which generally surround and enclose the axle shafts. Conventional axle tube housings are typically formed by a combination of cutting, forging, cropping, welding, and machining.

With particular reference to FIGS. 1-18, a conventional manufacturing method of a full-float axle tube is sequentially provided. As best seen in FIGS. 1 and 18 (step 50), the conventional method includes first cutting a thick walled tube into a first section 10 and a second section 12. First section 10 is to be used to manufacture the housing body or carrier, while second section 12 is to be used to manufacture the spindle. As seen in FIGS. 2 and 18 (step 52), first section 10 is then extruded to form an elongated member having walls of variable thickness. In FIGS. 3 and 18 (step 54), second section 12 is warm-formed in a two-stage progression to form the spindle blank. According to FIGS. 4 and 18 (step 56), the end of first section 10 and/or second section 12 is (are) then cropped to form an acceptable welding joint. As seen in FIGS. 5 and 18 (step 58), first section 10 and second section 12 are friction welded together to form an axle tube housing blank 14. As a byproduct of the friction welding process of first section 10 and second section 12, the resultant “rams horn” 16 (seen in FIG. 5) must then be machined or sheared off axle tube housing blank 14, as seen in FIGS. 6 and 18 (step 60).

With particular reference to FIGS. 7-10 and 18, a plurality of welding steps are required in order to attach any necessary brackets and the like. For example, a forged weld flange 18 is pressed on to axle tube housing blank 14 at a predetermined position as shown in FIGS. 7 and 18 (step 62). Forged weld flange 18 is subsequently fusion welded in position to axle tube housing blank 14. As seen in FIGS. 8, 9, and 18 (step 64), the remaining axle tube brackets, such as a spring seat 20 and a shock mount 22, are then conventionally welded to axle tube housing blank 14 in a predetermined position. Finally, as seen in FIGS. 10 and 18 (step 66), axle tube housing blank 14 is straightened as necessary.

Referring to FIGS. 11-18, axle tube housing blank 14 is then machined to provide the necessary finishing steps in the manufacturing process. To this end, a spindle end 24 and a rear end 26 of axle tube housing blank 14 are faced and centered according to known techniques (steps 68, 70, and 72); spindle 12, the face of weld flange 18, and the outer diameter of rear end 26 of axle tube housing blank 14 are also turned and/or roll threaded (steps 74, 76, 78, and 80); weld flange 18 is drilled and the resultant holes deburred (step 82); and finally the bearing and seal surfaces of axle tube housing blank 14 are finish ground, the keyway cut, and the final axle tube housing assembly is washed, rust proofed, packaged, and shipped.

However, as can be appreciated from the foregoing, the conventional method of manufacturing a full-float axle tube suffers from a number of disadvantages. By way of non-limiting example, this conventional manufacturing method requires an enormous amount of cycle time to cut, forge, extrude, weld, straighten, face, turn, and finish the axle tube housing blank, which increases the associated manufacturing costs and complexity.

Accordingly, there exists a need in the relevant art to provide a method of manufacturing an axle tube housing assembly that eliminates, as least in part, many of the requisite steps of the aforementioned conventional manufacturing process. Furthermore, there exists a need in the relevant art to provide a method of manufacturing an axle tube housing assembly quickly and conveniently without the need to first cut a tubular blank, process the sections separately, and later weld the sections back together. Still further, there exists a need in the relevant art to provide a method of manufacturing an axle tube housing from one-piece member. Additionally, there exists a need in the relevant art to provide a method of manufacturing an axle tube housing assembly that overcomes the disadvantages of the prior art.

### SUMMARY OF THE INVENTION

According to the principles of the present invention, a method of manufacturing an axle tube housing for a differential assembly is disclosed, which provides a number of unique advantages over conventional manufacturing methods. The method of the present invention includes heating a localized area of a one-piece tubular blank. A mandrel is inserted within the tubular blank and the localized area is then deformed to provide an increased wall thickness. A compression force is applied to the localized area of the one-piece tubular blank using a forging die to form a spindle section, wherein the spindle section closely conforms to at least one of the forging die and the mandrel. The remaining portion of the one-piece tubular blank is then cold reduced to form a carrier section.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIGS. 1-17 are a series of plan views illustrating the sequential manufacturing steps of an axle tube housing assembly according to the principles of the prior art;

FIG. 18 is a flowchart illustrating the sequential manufacturing steps of an axle tube housing assembly according to the principles of the prior art;

FIGS. 19-26 are a series of plan views illustrating the sequential manufacturing steps of an axle tube housing according to the principles of the present invention; and

FIG. 27 is a flowchart illustrating the sequential manufacturing steps of an axle tube housing assembly according to the principles of the present invention.

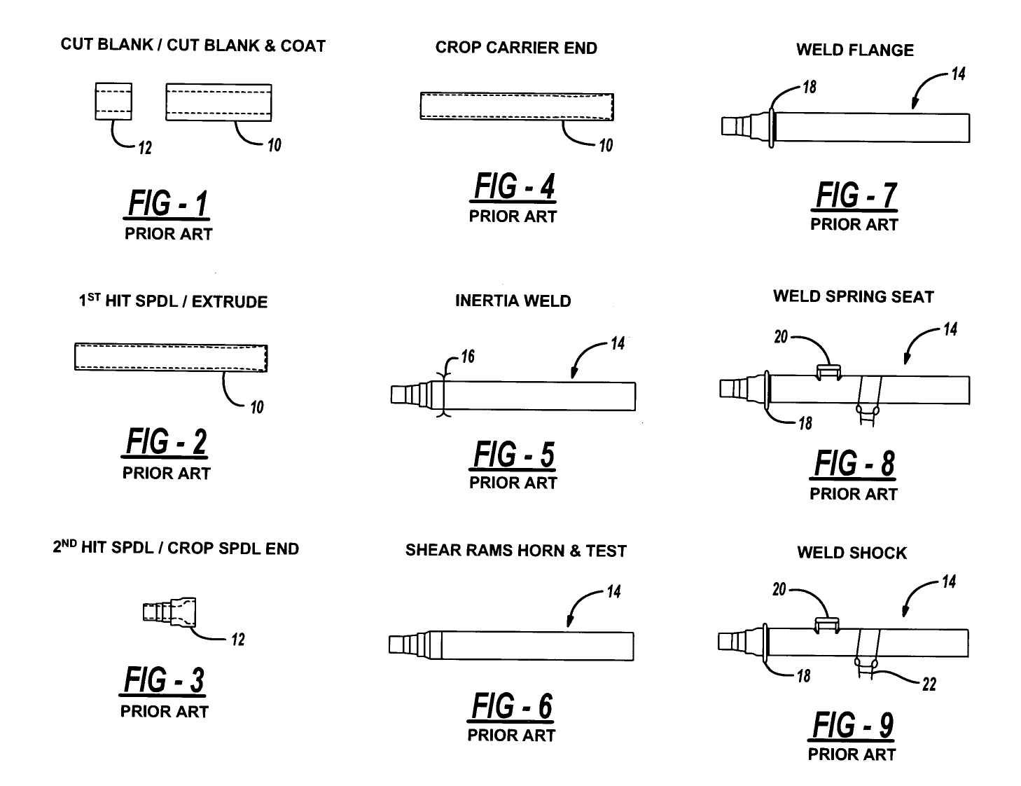

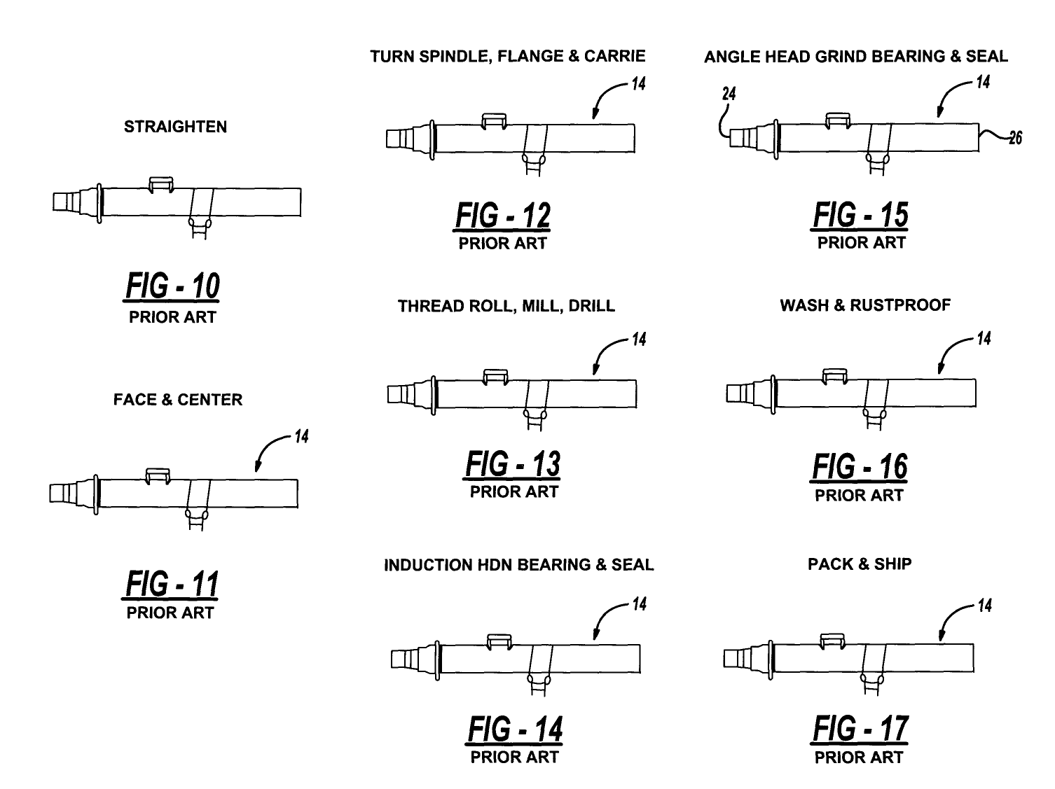

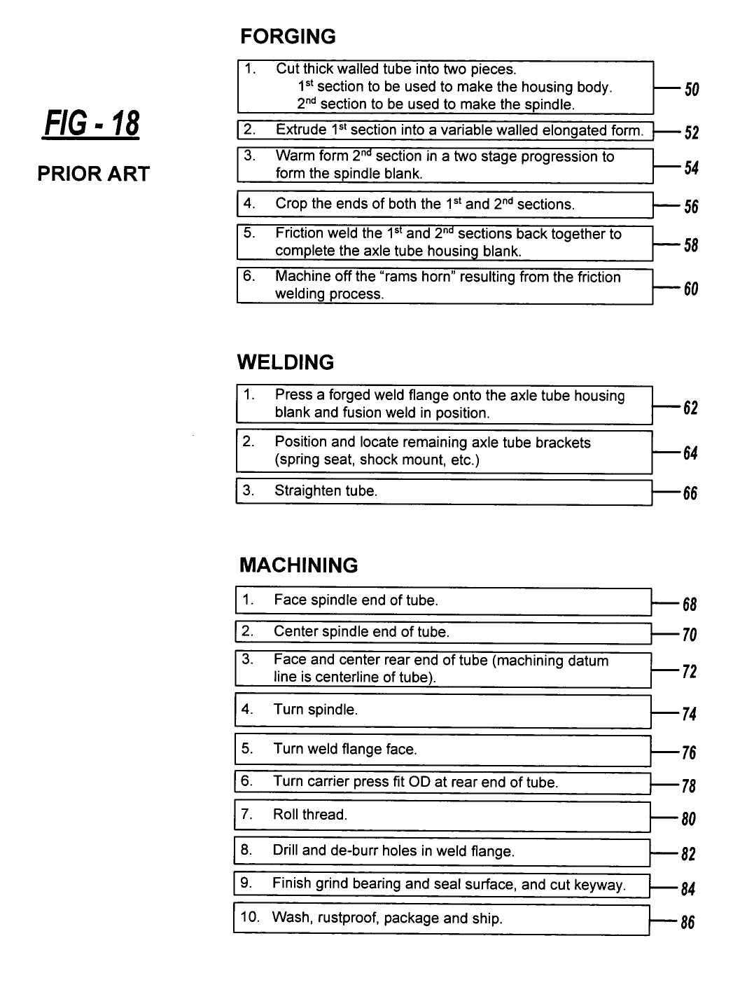

### DETAILED DESCRIPTION OF THE PREFERRED EMBODIMENTS

The following description of the preferred embodiment is merely exemplary in nature and is in no way intended to limit the invention, its application, or uses.

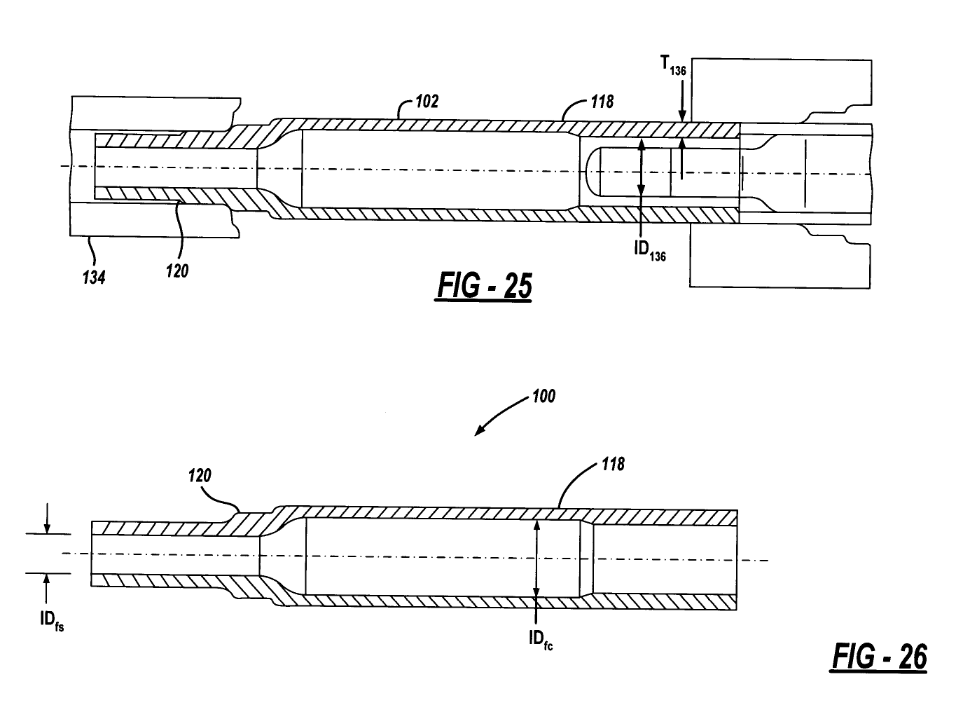

With particular reference to FIGS. 19-26, a preferred method of manufacturing an axle tube housing 100 (FIG. 26) is provided in accordance with the present invention. As will be readily appreciated from the following discussion, the present invention provides a number of advantages over the previously recited conventional manufacturing method. By way of non-limiting example, the present invention provides a method of manufacturing an axle tube housing 100 that eliminates a number of processing steps required in the conventional manufacturing method, such as the initial cutting of the tubular blank (step 50), the extruding of first section 10 (step 52), the warm forming of second section 12 (step 54), the cropping of the ends of first section 10 and/or second section 12 (step 56), the friction welding of first section 10 and second section 12 (step 58), the machining or shearing of the “ram's horn” 16 (step 60), the centering of the spindle end of first section 10 (step 70), the turning of the weld flange face (step 76), the turning of the outer diameter of first section 10 (step 78), and the drilling and deburring of the holes in the weld flange (step 82). Accordingly, it should be appreciated that the present invention maximizes the efficiency of the manufacturing process, thereby reducing the associated production costs thereof.

Referring now to FIGS. 19-26, a series of plan views illustrating the sequential manufacturing steps of an axle tube housing 100 is provided according to the principles of the present invention. According to a preferred embodiment, the conventional forging process is simplified, which further reduces much of the need for extensive welding and machining. As best seen in FIGS. 19-26, it should be readily appreciated that according to the present invention, the initial tubular blank is never cut into separate processing sections and, thus, does not require subsequent cropping, welding, or machining to join the sections back together. To this end, as seen in FIG. 19, a tubular blank 102 is first provided having a first end 104 and a second end 106. Tubular blank 102 further defines an initial outer diameter (ODₒ), an initial inner diameter (IDₒ), and a generally uniform wall thickness (Tₒ).

During an initial processing step, generally illustrated in FIG. 19, first end 104 of tubular blank 102 is heated to facilitate the forming thereof. Preferably, first end 104 is heated in a predetermined localized area 108 using an induction-heating element 110. Induction heating element 110 provides rapid, convenient, and discrete heating of predetermined localized area 108. However, it should be appreciated that any heating system may be used that promotes the malleability of tubular blank 102, such as a warming oven, flame application, and the like.

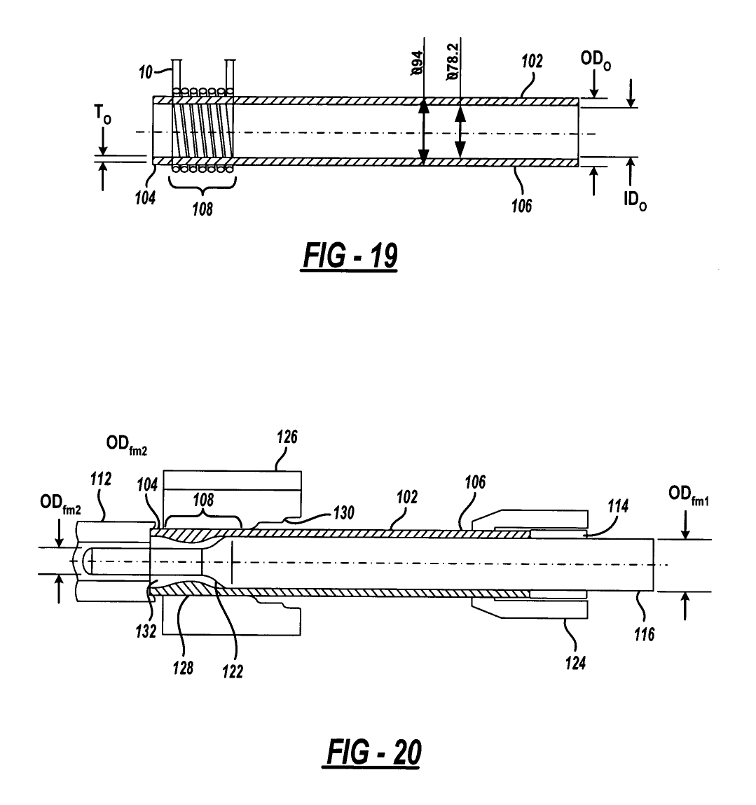

As best seen in FIG. 20, once predetermined localized area 108 is sufficiently heated, a first physical stop 112 is positioned and engaged in contact with first end 104 of tubular blank 102. Similarly, a second physical stop 114 is positioned and engaged in contact with opposing second end 106 of tubular blank 102. Preferably, at least one of first physical stop 112 and second physical stop 114 is movable relative to the other to produce a clamping force upon tubular blank 102.

Still referring to FIG. 20, a forming mandrel 116 is provided having a cross-sectional profile defined by the present design criteria. However, it should be appreciated that the specific cross-sectional profile of forming mandrel 116 may vary depending upon different axle tube housing assembly applications. In the present embodiment, forming mandrel 116 includes a first outer diameter (OD_{fm1}), which is preferably sized to closely conform to a final desired inner diameter (ID_{fc}) of a carrier section 118 (FIG. 26) of axle tube housing 100. Forming mandrel 116 further includes a second outer diameter (OD_{fm2}), which is preferably sized to closely conform to a final desired inner diameter (ID_{fs}) of a spindle section 120 (FIG. 26) of axle tube housing 100. A shoulder portion 122 extends between first outer diameter (OD_{fm1}) and second outer diameter (OD_{fm2}). Initially, forming mandrel 116 is inserted into locally heated tubular blank 102 such that shoulder portion 122 of forming mandrel 116 is generally adjacent localized area 108.

A clamping jaw 124 engages second end 106 of tubular blank 102 to retain tubular blank 102 in a position relative to forming mandrel 116 and second physical stop 114. A forging die 126 is provided having an inner forging contour that defines a generally flat section 128 and a generally shaped section 130. Forging die 126 is generally conventional in operation and, thus, in the interest of brevity, its specific construction will not be described herein.

Still referring to FIG. 20, according to the forging process of the present invention, tubular blank 102 is initially positioned such that first physical stop 112 engages first end 104, second physical stop 114 engages second end 106, clamping jaw 124 engages second end 106, and forming mandrel 116 is inserted therein. Generally flat section 128 of forging die 126 is then positioned generally adjacent localized area 108. At this point, first physical stop 112 and/or second physical stop 114 are actuated to apply a compression force longitudinally along tubular blank 102. As can be seen in FIG. 20, this longitudinal compression force causes heated localized area 108 to deform inwardly into a void 132 defined by generally-flat section 128 of forging die 126, shoulder portion 122 of forming mandrel 116, and first physical stop 112. This operation causes the wall thickness of tubular blank 102 to increase generally along localized area 108. This increased wall thickness provided the necessary material for later forming operations.

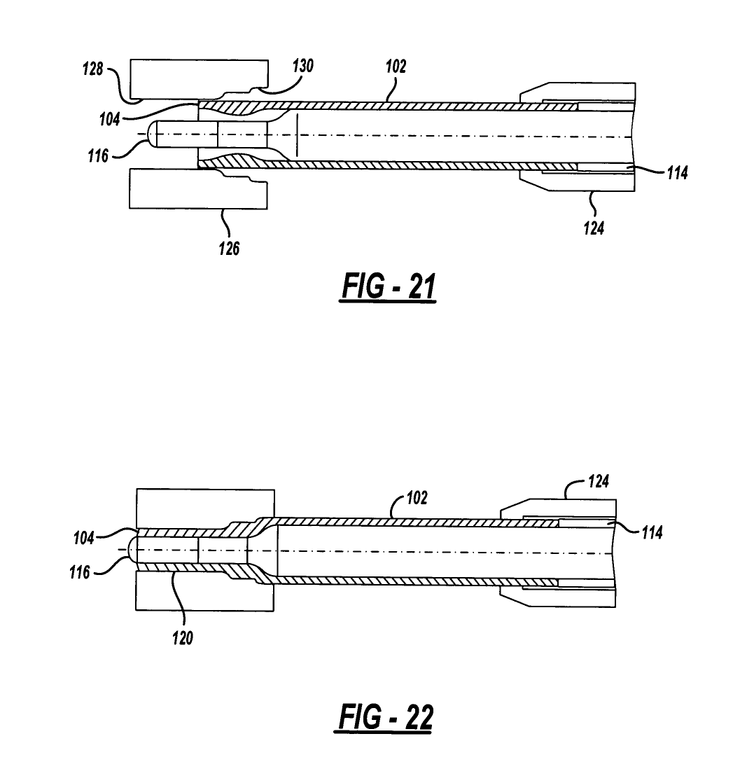

Referring now to FIG. 21, it can be seen that first physical stop 112 may now be removed and forming mandrel 116 may be partially retracted (to the right in FIG. 21). Forging die 126 is then repositioned (to the left in FIG. 21) such that a portion of generally flat section 128 is adjacent first end 104. As seen in FIG. 22, forging die 126 is then actuated to separately or simultaneously move inwardly around forming mandrel 116 and to the right against shoulder portion 122. This operation serves to initially reduce and shape first end 104 of tubular blank 102 to conform closely to forming mandrel 116 and generally shaped section 130 of forging die 126. It should also be understood that this technique further provides enormous control over the wall thickness of spindle section 120. In other words, the relative position of forging die 126 and forming mandrel 116 defines areas where additional material (i.e. metal material) may be concentrated. This is particularly useful to provide improved strength capability in known failure locations (i.e. corners, bearing positions, etc.).

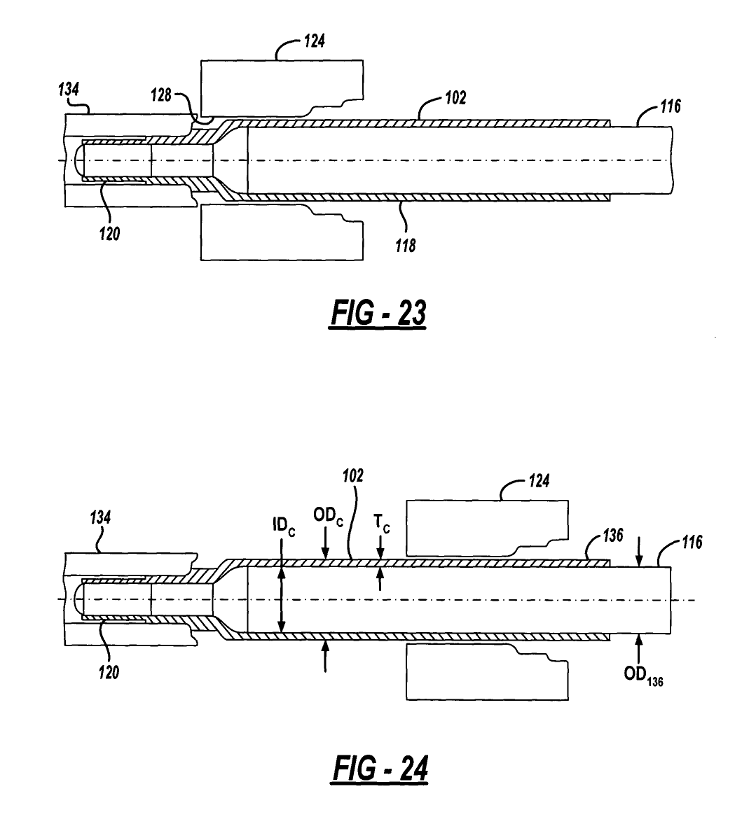

With reference to FIG. 23, it can be seen that forging die 126 may now be retracted from tubular blank 102 and a second forging die 134, having similar construction to forging die 126, may now be used to form a final shape at spindle section 120 in a similar operation as previously described. It should be appreciated, however, that second forging die 134 may not be necessary in all applications.

Still referring to FIG. 23, generally flat section 128 of forging die 134 is now positioned adjacent carrier section 118 of tubular blank 102. Accordingly, as seen in FIGS. 23-24, forging die 134 is then drawn along at least a portion of carrier section 118 to cold reduce the wall thickness (T) of at least a portion of carrier section 118 and, additionally, closely conform the inner diameter (ID) of carrier section 118 to the outer diameter (OD_{fm1}) of forming mandrel 116. Hence, following this operation (FIG. 24), wall thickness (T_{c}) of carrier section 118 is less than initial wall thickness (Tₒ), outer diameter (OD_{c}) of carrier section 118 is less than initial outer diameter (ODₒ), and inner diameter (ID_{c}) of carrier section 118 is less than initial inner diameter (IDₒ).

Preferably, as seen in FIG. 24, such cold reduction of carrier section 118 is performed only along a portion of carrier section 118, thereby leaving a section 136 having initial (enlarged) wall thickness (Tₒ). If preferred, the outer diameter (OD₁₃₆) of section 136 can be reduced to be consistent with the adjacent cold-reduced section of carrier section 118 (OD_{c}). That is, forming mandrel 116 may be retracted (moved to the right in FIG. 25) such that forming mandrel 116 no longer engages an inner diameter (ID₁₃₆) of section 116. Forging die 134 is then drawn along section 136 to cold reduce the outer diameter thereof, without dramatically affecting the wall thickness (T₁₃₆) of section 136. The resultant effect of this process is to provide locations along carrier section 118 where the wall thickness may be increased or decreased in accordance with the necessary structural loading requirements. Therefore, areas that contribute less to structural loading capacity may be thinner, thereby reducing the total weight of the assembly. Conversely, areas that contribute greater to structural loading capacity may be thicker, thereby improving the overall structural integrity. It should be understood that the thickness of carrier section 118 may be varied along its length as necessary to maximize integrity while minimizing weight and cost.

As can be appreciated from FIG. 26, as a result of the above operations, axle tube housing 100 is now forged from a single unitary tubular blank. The final forged axle tube housing 100 thus includes spindle section 120 having a cross-sectional profile that varies in wall thickness, a first portion of carrier section 118 having a generally uniform wall thickness, and a second portion of carrier section 118 having a generally uniform wall thickness greater than the first portion.

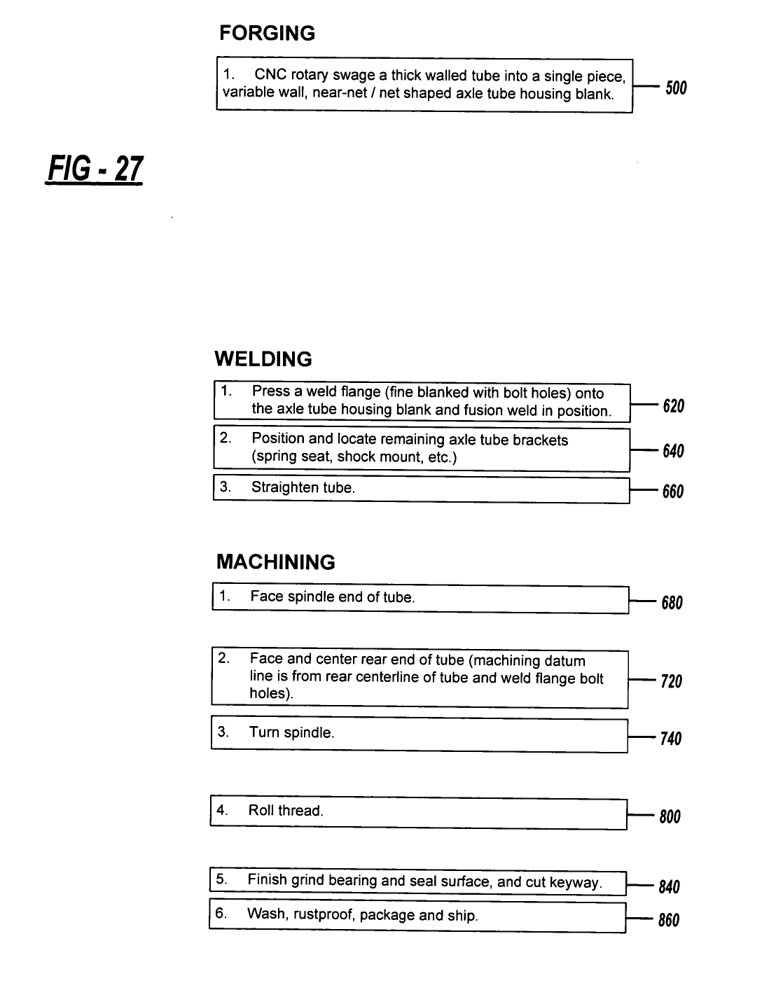

Additionally, as seen in FIG. 27, further processing of axle tube housing 100 may include a plurality of bracket welding steps, which is dependent upon the specific application and vehicle design. One important process step reduction feature is to provide a flat steel plate with precision, fine-blanked, brake backing plate 180 with mounting holes as a substitute for the conventionally-formed, unfinished, no-holed, weld flange bracket 18. Plate 180 is pressed on to axle tube housing 100 at a predetermined position relative to an established datum (step 620). Plate 180 is subsequently fusion welded in a final position to axle tube housing 100, without the need for additional centering or machining. That is, conventional flange 18 must be first centered (thickness machined down to establish a relative distance between flange 18 and a datum) and subsequently drilled and deburred prior to use. However, plate 180 may conveniently be mounted to axle tube housing 100 as a finished member, without the need for difficult and time consuming centering and drilling. The remaining axle tube brackets, such as a spring seat and a shock mount, may then be welded to axle tube housing 100 in a predetermined position (step 640). Finally, axle tube housing 100 may then be straightened as necessary (step 660).

Still referring to FIG. 27, axle tube housing 100 may then be machined to provide the necessary finishing steps in the manufacturing process. To this end, spindle section 120 is faced (step 680), although due to the one-piece construction of the present invention, spindle section 120 need not be centered as required by conventional manufacturing processes (the datum line for all subsequent spindle turning operations may be defined by the line passing through the center line of the rear end of axle tube housing 100 and extending through the center of the tube engagement hole in the fine blanked weld flange plate 180); second end 106 of carrier section 118 is faced and centered (step 720); spindle section 120 of axle tube housing 100 is turned and/or roll threaded (steps 740 and 800); and finally the bearing and seal surfaces of axle tube housing 100 are finish ground, the keyway cut, and the final axle tube housing assembly is washed, rust proofed, packaged, and shipped (steps 840 and 860).

From the foregoing, it will be appreciated by one skilled in the art that the manufacturing method of the present invention provides a number of advantages over conventional manufacturing methods in that the present invention improves the structural integrity of the axle tube housing by using a single, unitary member; eliminates the need for cutting, processing, and welding of multiple sections; reduces the need for complex machinery; and finally minimizes cycle time and associated costs. Furthermore, on a granular level, it should be understood that the method of manufacturing according to the present invention provides an axle tube housing that employs a substantially homogenous grain structure throughout its length by virtue of its unitary construction, thereby providing a more consistent and predictable member.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of manufacturing an axle tube housing for a differential assembly, the method comprising:
inserting a mandrel within a one-piece tubular blank;
applying an axial compression force to a first segment of said one-piece tubular blank;
applying a lateral compressing force to said first segment of said one-piece tubular blank to define a spindle section that closely conforms with at least one of a forging die and said mandrel; and
reducing a wall thickness of at least a portion of a second segment of said one-piece tubular blank to define a carrier section.

2. The method according to claim 1, further comprising:
heating said first segment of said one-piece tubular blank prior to said deforming said first segment.

3. The method according to claim 1, further comprising:
mounting a preformed plate to said one-piece tubular blank in a predetermined position, said preformed plate defining a final thickness prior to said mounting.

4. The method according to claim 3 wherein said step of mounting a preformed plate to said one-piece tubular blank in said predetermined position comprises:
forming at least one hole through said preformed plate; and
fusion welding said preformed plate to said one-piece tubular blank following said forming said at least one hole.

5. The method according to claim 1 wherein said deforming said first segment includes cold-forming.

6. The method according to claim 1 wherein said deforming said first segment includes hot-forming.

7. A method of manufacturing an axle tube housing for a differential assembly, the method comprising:
heating a spindle segment of a one-piece tubular blank;
inserting a mandrel within said one-piece tubular blank;
deforming said spindle segment of said one-piece tubular blank;
applying a lateral compressing force to said spindle segment of said one-piece tubular blank to closely conform with at least one of a forging die and said mandrel; and
reducing a wall thickness of at least a portion of a carrier segment of said one-piece tubular blank.

8. The method according to claim 7, further comprising:
mounting a pre-faced and drilled plate to said one-piece tubular blank in a predetermined position.

9. The method according to claim 8 wherein said step of mounting said pre-faced and drilled plate to said one-piece tubular blank in said predetermined position includes fusion welding said pre-faced and drilled plate to said one-piece tubular blank.

10. The method according to claim 7 wherein said deforming said spindle segment includes cold-forming.

11. The method according to claim 7 wherein said deforming said spindle segment includes hot-forming.

12. A method of manufacturing an axle tube housing for a differential assembly, the method comprising:
heating a spindle segment of a one-piece tubular blank;
inserting a mandrel within said one-piece tubular blank;
applying a compressing force to said spindle segment of said one-piece tubular blank to closely conform with at least one of a forging die and said mandrel;
forming said spindle segment of said one-piece tubular blank using at least said forging die; and
reducing a wall thickness of a first portion of a carrier segment of said one-piece tubular blank.

13. The method according to claim 12, further comprising:
at least partially removing said mandrel from within said one-piece tubular blank; and
reducing an outer diameter of a second portion of said carrier segment such that a wall thickness of said second portion of said carrier segment is greater than said wall thickness of said first portion of said carrier segment.

14. The method according to claim 13 wherein said reducing said outer diameter of said second portion of said carrier segment includes cold forming.

15. The method according to claim 12, further comprising:
mounting a pre-faced and drilled plate to said one-piece tubular blank in a predetermined position.

16. The method according to claim 15 wherein said step of mounting said pre-faced and drilled plate to said one-piece tubular blank in said predetermined position includes fusion welding said pre-faced and drilled plate to said one-piece tubular blank.

17. An axle tube housing comprising:
a spindle segment; and
a carrier segment integrally formed with said spindle segment, said carrier segment and said spindle segment having substantially homogenous grain structure.

18. The axle tube housing according to claim 17 wherein said spindle segment has varying wall thicknesses.

19. The axle tube housing according to claim 17 wherein said carrier segment has varying wall thicknesses.
